(19) United States
(12) Patent Application Publication
(10) Pub. No.: US 2003/0110367 A1
(43) Pub. Date: Jun. 12, 2003

(54) External microcode

(75) Inventors: Howard Chin, Santa Clara, CA (US); George Thangadurai, Santa Clara, CA (US)

Correspondence Address: SCHWEGMAN, LUNDBERG, WOESSNER & KLUTH, P.A., P.O. BOX 2938, MINNEAPOLIS, MN, 55402, US

(73) Assignee: Intel Corporation

(21) Appl. No.: 10/304,199

(22) Filed: Nov. 26, 2002

Related U.S. Application Data
(62) Division of application No. 09/476,622, filed on Dec. 31, 1999.

(51) Int. Cl. G06F 9/44

(52) U.S. Cl. 712/245

(57) ABSTRACT

Some embodiments of the invention include a computer system comprising a bus, a processor and a computer readable medium external to the processor. The computer readable medium is coupled to the processor by the bus and stores instructions to implement microcode functions. Some other embodiments of the invention include a method of using firmware as microcode. The method comprises storing programmed code in firmware and executing the programmed code. The method further comprises updating one or more registers associated with a logic unit on the processor in response to the execution of the programmed code and controlling one or more functions of the logic unit on the processor based on a value stored in the register.

This application is a divisional of U.S. application Ser. No. 09/476,622 filed Dec. 31, 1999.

### FIELD

The present invention is related to processors, and more particularly to microcode for processors.

### BACKGROUND INFORMATION

A computer system can be broken into three basic blocks: a central processing unit (CPU), memory, and input/output (I/O) units. These blocks are interconnected by means of a bus. An input device such as a keyboard, mouse, disk drive, analog-to-digital converter, etc., is used to input instructions and data to the computer system via the I/O unit. These instructions and data can be stored in memory. The CPU retrieves the data stored in the memory and processes the data as directed by the stored instructions. The results can be stored back into memory or outputted via the I/O unit to an output device such as a printer, cathode-ray tube (CRT) display, digital-to-analog converter, liquid crystal display (LCD), etc.

The function of the CPU (also referred to herein as a processor) is to execute programs. Programs comprise a group of instructions. Each instruction is broken down into one or more operations known as micro-instructions or micro-operations. One way that processors execute micro-instructions is by reading operands from one or more source registers and storing results in one or more destination registers. A register is a temporary storage area within a processor for holding data used by the processor. Registers store bits. A bit is a binary digit and represents either a “0” value or a “1” value. Different registers may be used for different functions. For example, general purpose registers are used interchangeably to hold operands for logical and arithmetic operations. Special purpose registers may be used for holding status information via various flag bits, for example.

Certain processor operations are easier to implement using a hybrid of programmed code and hardware logic than using just hardware logic alone. For example, these operations can be processor internal operations or a complex instruction (or part of the instruction operation) that uses programmed code to simplify logic implementation. The programmed code used to simplify logic implementation is called “microcode.”

Traditionally, the microcode is embedded inside the microprocessor because the microcode is tightly coupled with the hardware logic. Traditional microcodes are pre-programmed binary bits that reside inside a processor.

However, traditional implementations for microcode have several disadvantages. For example, because each bit of microcode takes up precious die area, microcode is often limited in size and is very expensive. As processors become more and more complex, microcode also becomes huge in size, occupying a large share of the processor silicon. In addition, because traditional microcode resides inside a processor, the microcode can only be changed by repeating the entire processor design and manufacturing cycle—much like hardware logic changes.

For these and other reasons, there is a need for the present invention.

### SUMMARY

Some embodiments of the invention include a computer system comprising a bus, a processor and a computer readable medium external to the processor. The computer readable medium is coupled to the processor by the bus and stores instructions to implement the microcode functions.

Still other and further embodiments, aspects and advantages of the invention will become apparent by reference to the drawings and by reading the following detailed description.

### BRIEF DESCRIPTION OF THE DRAWINGS

FIG. 1 is a block diagram of an example embodiment of a system according to the present invention.

FIG. 2A is a more detailed block diagram of an example embodiment of the processor and firmware shown in FIG. 1.

FIG. 2B is a block diagram of an alternate embodiment of the processor shown in FIG. 1 and external microcode stored on a computer readable medium.

FIG. 3 is a more detailed block diagram of an example embodiment of the processor and machine specific registers shown in FIG. 2A.

FIG. 4 is a more detailed block diagram of an example embodiment of the machine specific registers shown in FIG. 3.

FIG. 5 is a flow chart of a method of using firmware as microcode according to an example embodiment of the present invention.

FIG. 6 is a flow chart of an alternate embodiment of a method of using external microcode according to one embodiment of the present invention.

### DETAILED DESCRIPTION

In the example embodiments described below, at least some of the microcode for a processor resides on a computer readable medium which is external to the processor. In the following detailed description of embodiments, reference is made to the accompanying drawings which form a part hereof, and in which are shown by way of illustration specific embodiments in which the invention may be practiced. It is to be understood that other embodiments may be utilized and structural changes may be made without departing from the scope of the present invention.

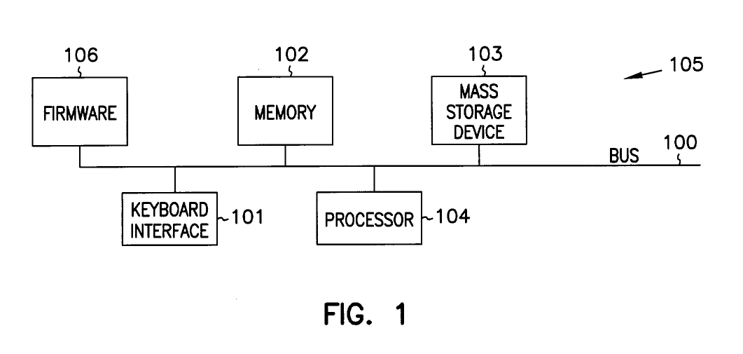

FIG. 1 is a block diagram of a system, such as a computer system 105, of an example embodiment of the present invention. The computer system 105 comprises bus 100, keyboard interface 101, external memory 102, mass storage device 103, processor 104 and firmware 106. Bus 100 may be a single bus or a combination of multiple buses. Bus 100 provides communication links between components in the system. Keyboard interface 101 may be a dedicated device or may reside in another device such as a bus controller or other controller. Keyboard interface 101 allows coupling of a keyboard to the system and transmits signals from a keyboard to the system. External memory 102 may comprise a dynamic random access memory (DRAM) device, a static random access memory (SRAM) device, or other memory devices. External memory 102 stores information from mass storage device 103 and processor 104 for use by processor 104. Mass storage device 103 may be a hard disk drive, a floppy disk drive, a CD-ROM device, or a flash memory device or the like. Mass storage device 103 provides information to external memory 102. Firmware 106 is nonvolatile memory programmed with data or instructions. Examples of firmware 106 include, but are not limited to, read-only memory (ROM), programmable read-only memory (PROM), and electrically erasable programmable read-only memory (EEPROM), and flash memory.

The processor 104 may be compatible with, but not limited to, processors such as an Intel® architecture processor, manufactured by Intel Corporation of Santa Clara, Calif., the assignee of the present invention. In alternate embodiments, the processor 104 may be compatible with a PowerPC™ architecture processor, an Alpha™ architecture processor, and the like.

In previous systems, a processor utilized microcode stored on the processor to generate signals for controlling the behavior of various processor hardware. Unlike previous systems, embodiments of the present invention permit some programmed code that was previously stored as microcode on the processor 104 to instead be stored on a computer readable medium that is external to the processor 104. Examples of computer readable mediums external to the processor include, but are not limited to, mass storage devices 103, firmware 106 and memory 102. In one embodiment, the computer readable medium stores microcode instructions for non-performance critical operations. Examples of non-performance critical operations include, but are not limited to, cache flushing, cache invalidation, setting and reading processor features and configurations, machine check handling, floating point calculations, processor diagnosis, Intel 32 bit architecture handling (for backward compatibility), authentication, platform management interrupt, diagnostic and debug functionality and so on.

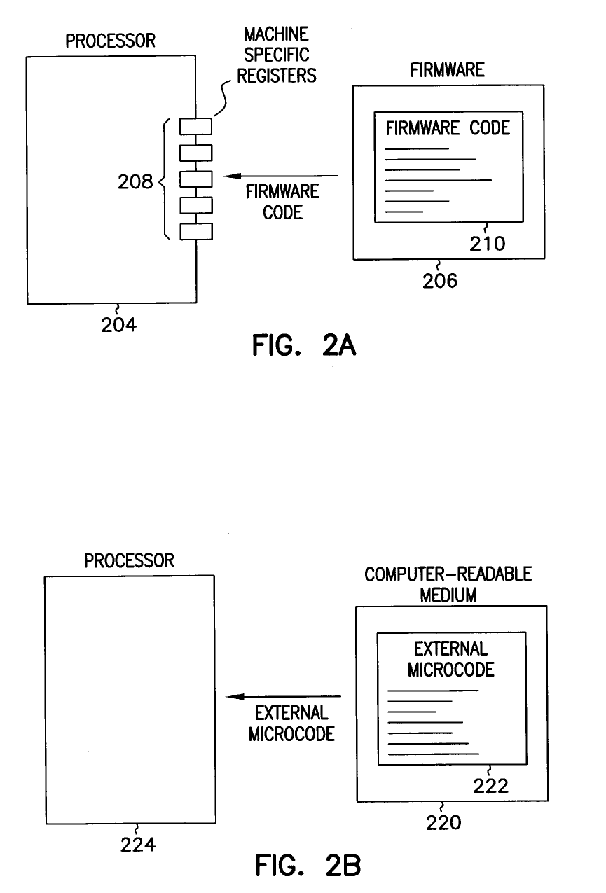

FIG. 2A is a more detailed block diagram of an example embodiment of the processor and firmware shown in FIG. 1. In one embodiment of the invention, firmware 206 stores programmed code 210 for controlling the operation of the processor 204. The programmed code 210 stored in the firmware 206 is referred to herein as the “firmware code.” In an example embodiment, the firmware code 210 implements microcode operations using registers which are specific to a particular machine or to a particular model of a machine. The registers are referred to herein as “Machine Specific Registers.” The machine specific registers function as an interface between the firmware 206 and the processor 204.

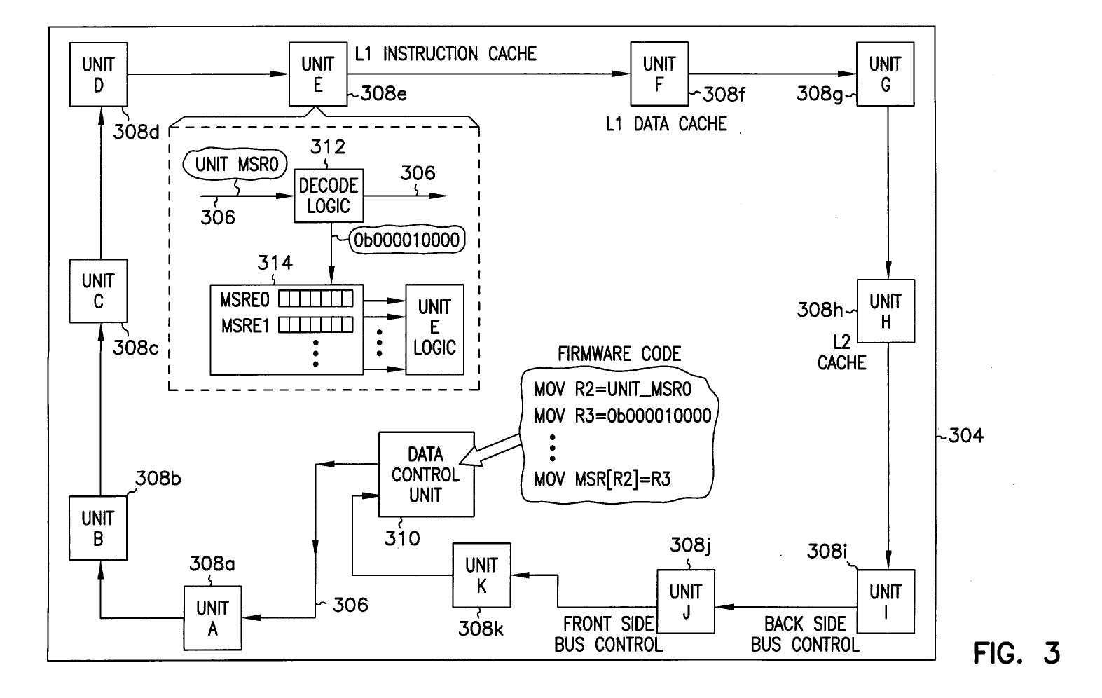

In the example embodiment shown in FIG. 2A, processor 204 includes a plurality of machine specific registers (MSRs) 208. In one embodiment, one or more of the MSRs 208 are associated with one or more functional units of the processor 204. For example, an MSR bank may be associated with an external bus unit, while another MSR bank might be associated with the processor's cache. Each one of the MSRs 208 store one or more bits. The size of an MSR may vary between the functional units. The bits stored by the MSRs 208 are updated when the firmware code 210 stored in the firmware 206 is executed by the processor 204. In one embodiment, the value of each one of the bits stored in the MSR 208 affects the behavior of the functional unit of the processor 204 that the MSR 208 is associated with. In an alternate embodiment, the value of one or more bits stored in the MSR 208 affects the behavior of a different functional unit of the processor than the functional unit that the MSR 208 is associated with. The MSRs enable the firmware to be used as external microcode for use by the processor as further described by reference to FIGS. 3, 4 and 5 below.

However, embodiments of the invention are not limited to storing microcode instructions in firmware. Alternate embodiments are also contemplated which have instructions for performing microcode operations stored on any computer readable medium external to the processor. Furthermore, embodiments of the invention are not limited to using registers as an interface for the external microcode stored on the computer readable medium. In an alternate embodiment, the external microcode directly manipulates hardware logic on the processor without using the MSRs.

FIG. 2B is a block diagram of an alternate embodiment of the processor shown in FIG. 1 and external microcode stored on a computer readable medium. In one embodiment of the invention, a computer readable medium 220, which is external to the processor, stores programmed code 222 for controlling the operation of the processor 224. Examples of computer readable mediums external to the processor include, but are not limited to, mass storage devices, firmware and memory. The programmed code 222 stored in the computer readable medium is referred to herein as “external microcode.” In an example embodiment, the external microcode 222 implements microcode operations by controlling hardware logic on the processor 224 without the use of the registers shown in FIG. 2A. In an alternate embodiment, the external microcode 222 implements microcode operations using the registers shown in FIG. 2A as an interface to the processor hardware logic. In still another embodiment, the external microcode 222 implements microcode operations by a combination of using the registers shown in FIG. 2A and by directly triggering the processor hardware logic.

FIG. 3 is a more detailed block diagram of the processor and machine specific registers shown in the example embodiment in FIG. 2A. The processor 304 shown in FIG. 3 comprises a control register access bus (CRAB) bus 306, a data control unit 310, and a plurality of functional units 308a, 308b, 308c, 308d, 308e, 308f, 308g, 308h, 308i, 308j, 308k.

The CRAB 306 provides communication links between the functional units 308a-308k of the processor 304 and the data control unit 310. The data control unit 310 executes the various instructions provided to control the operations of the system. In one embodiment, the data control unit 310 fetches an instruction from memory or from firmware or from any other computer readable medium external to the processor. The data control unit 310 then decodes the instruction into one or more operations known as microinstructions. In one embodiment, logical source and destination registers for each microinstruction are general purpose registers. According to one embodiment of the present invention, the logical source or destination register for some of the microinstructions fetched from the firmware is one of the machine specific registers such as the MSR 314 for functional unit E 308e.

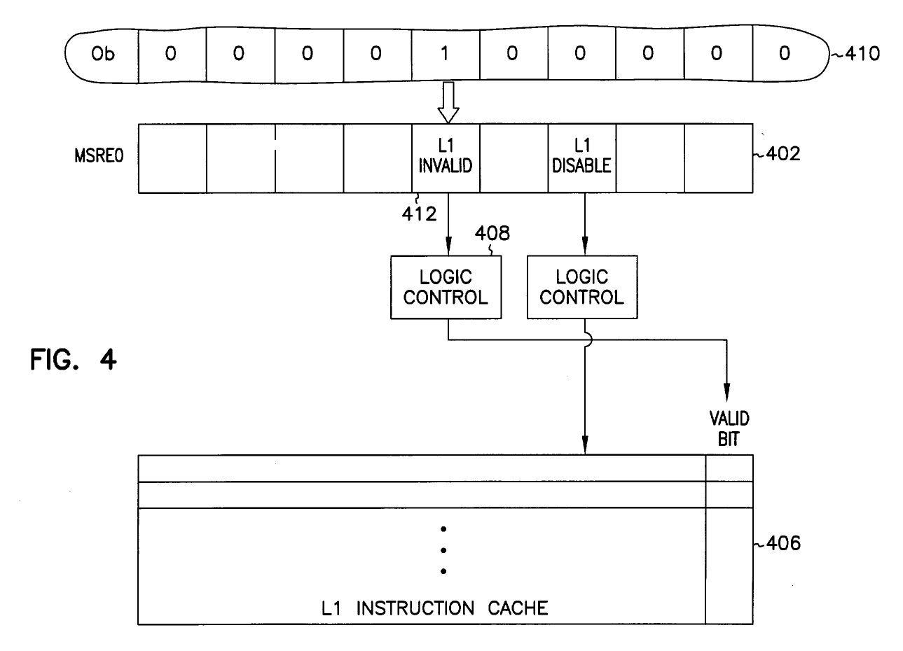

In one embodiment, the plurality of functional units 308a, 308b, 308c, 308d, 308e, 308f, 308g, 308h, 308i, 308j, 308k represent the processor's internal hardware logic. In the example embodiment shown in FIG. 3, functional unit E 308e represents an L1 instruction cache; functional unit F 308f represents is L1 data cache; functional unit H 308h represents an L2 cache; function unit I 308i represents a backside bus controller; and functional unit J 308j represents a front side bus controller. In one embodiment, one or more of the functional units 308a-308k of the processor 304 have an MSR 314 register associated with the functional unit. FIG. 3 includes an exploded view of functional unit E 308e for the L1 instruction cache. Associated with functional unit E 308e is decode logic 312 and one or more MSR registers 314. The decode logic 312 determines the MSR address of an instruction on the CRAB 306. Functional unit E 308e also contains one or more MSRs which are described in more detail by reference to FIG. 4.

FIG. 4 is a more detailed block diagram of one embodiment of the MSR shown in FIG. 3. As shown in FIG. 4, one of the MSRs 402 for functional unit E controls certain functions of the L1 instruction cache 406. Each one of the MSRs, such as the MSR 402 for functional unit E, are coupled to internal logic for the processor and each bit or group of bits 410 in an MSR register affects the processor's behaviors. For example, one bit 412 of the MSR 402 controls the invalidation of a cache line in the L1 instruction cache 406. When the MSR bit four is set to “1,” the control logic 408 to invalidate the cache line in the L1 instruction cache is triggered.

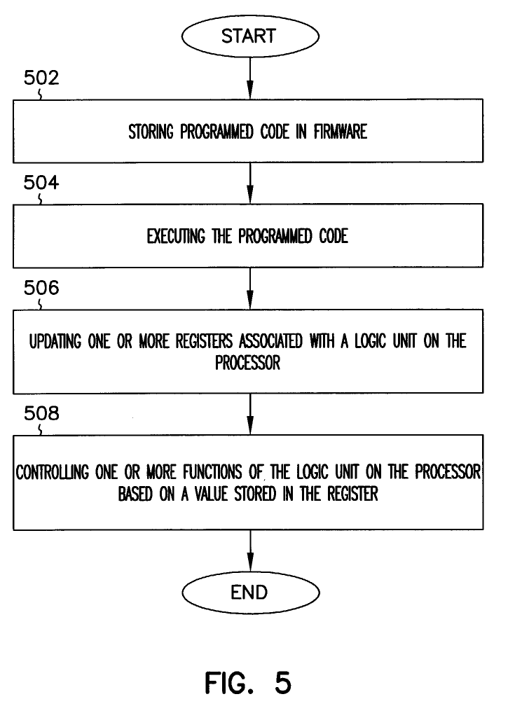

FIG. 5 is a flow chart of an embodiment of a method of using firmware as microcode according to one embodiment of the present invention. In one embodiment, programmed code is stored in firmware (block 502). For example, the programmed code is stored in firmware in assembly language. The programmed code is executed by a processor (block 504) and the one or more registers associated with a logic unit on the processor are updated or read in response to the execution of the programmed code (block 506). In one embodiment, one or more of the instructions in the programmed code cause the processor to move a value from one of the processor's general purpose registers to a machine specific register (MSR). The instruction updates one or more of the bits stored in the MSR. In the example embodiment shown in FIG. 4, the CRAB bus transfers data to the MSR register to be updated. In an alternate embodiment, an instruction in the programmed code reads an MSR by moving a value in the MSR to a general purpose register. In another embodiment, the MSR is used to communicate information to external microcode such as information about a current state of the processor or information about past events. One or more functions of the logic unit on the processor are controlled based on a value stored in the register (block 508). One embodiment of a method of using firmware as microcode shown in FIG. 5 allows MSR bit values to be changed by using specific assembly language instructions.

FIGS. 3, 4 and 5 illustrate example embodiments of the invention which store microcode instructions in firmware and which use machine specific registers as an interface. However, embodiments of the invention are not limited to storing microcode instructions in firmware. Furthermore, embodiments of the invention are not limited to using registers as an interface for the external microcode. In alternate embodiments, the microcode is stored on any computer readable medium external to the processor and/or the microcode directly manipulates hardware logic on the processor without the use of machine specific registers.

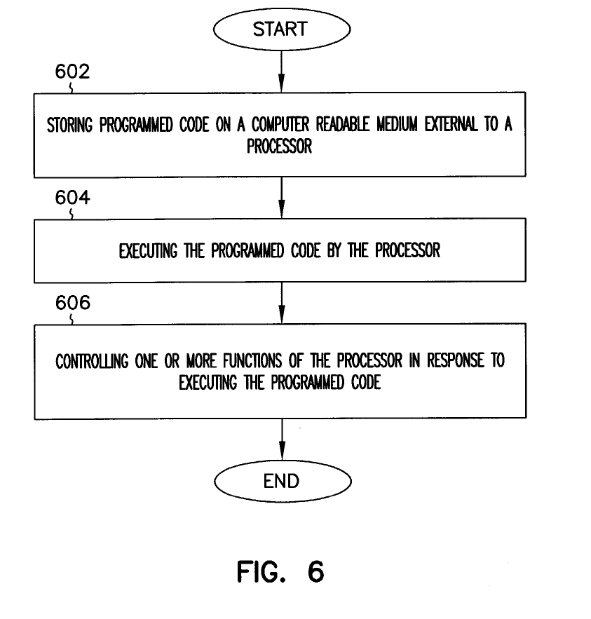

FIG. 6 is a flow chart of an alternate embodiment of a method of using external microcode according to one embodiment of the present invention. As shown in FIG. 6, the method begins by storing programmed code on a computer readable medium external to a processor (block 602). The processor executes the programmed code (block 604). One or more functions of the processor are controlled in response to executing the programmed code (block 606). In one embodiment the one or more functions are controlled (block 606) by directly triggering hardware on the processor in response to executing the programmed code. In another embodiment, the one or more functions are controlled (block 606) by updating one or more registers associated with a logic unit on the processor in response to executing the programmed code. In still another embodiment, the one or more functions are controlled (block 606) by triggering processor hardware logic and by manipulating the plurality of registers.

By using microcode that is stored outside the processor, the cost of implementing microcode is significantly reduced because the code size restriction for the microcode is removed. External microcode according to one embodiment of the invention can also be reprogrammed easily and therefore increases the ease of debugging microcode. The ability to reprogram also makes errata fixes possible, much like a software patch, even after a processor is out in the market. Embodiments of the invention overcome the traditional requirement that microcode is so tightly coupled to the processor logic that the microcode must to be placed on the processor die.

Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. Therefore, it is intended that this invention be limited only by the claims and the equivalents thereof.

What is claimed is:

1. A computer system, comprising:
a bus;
a processor; and
a computer readable medium external to the processor and capable of being operatively coupled to the processor by the bus, the computer readable medium to store instructions to implement microcode functions, wherein the processor further comprises a plurality of machine specific registers associated with one or more functional units of the processor, and wherein execution of said instructions implement microcode functions affects operation of at least one of the plurality of machine specific registers.

2. The computer system of claim 1, wherein the instructions implement microcode functions by updating one or more of the plurality of machine specific registers.

3. The computer system of claim 1 wherein the instructions implement microcode functions by reading one or more of the plurality of machine specific registers.

4. A method of using firmware as microcode, the method comprising:
storing programmed code in firmware external to a processor;
executing, by the processor, the programmed code;
updating one or more machine specific registers associated with a logic unit included in the processor in response to the executing of the programmed code; and
controlling one or more functions of the logic unit on the processor based on a value stored in the one or more of the machine specific registers.

5. The method of claim 4, wherein controlling one or more functions of the logic unit on the processor based on a value stored in the one or more of the machine specific registers further includes:
controlling a non-performance critical function.

6. The method of claim 5, wherein the non-performance critical function is selected from the group consisting of:
cache flushing, cache invalidation, setting processor features, reading processor features, machine check handling, floating point calculations, processor diagnosis, architecture handling for backward compatibility, authentication, platform management interrupt, diagnostic functions and debug functions.

7. A processor comprising:
a plurality of logic units; and
one or more machine specific registers associated with each one of the plurality of logic units, the one or more machine specific registers to trigger processor hardware logic functions when one of the one or more machine specific registers is updated in response to executing an external microcode instruction.

8. The processor of claim 7, wherein one of the plurality of logic units is associated with at least two machine specific registers.

9. The apparatus of claim 7, wherein changing a value of at least one bit in a selected one of the one or more machine specific registers affects the behavior of a selected one of the plurality of logic units.

10. A method comprising:
storing programmed code on a computer readable medium external to a processor;
executing, by the processor, the programmed code; and
controlling one or more functions of the processor in response to executing the programmed code, wherein the one or more functions are controlled by updating at least one machine specific register associated with a logic unit of the processor and by directly triggering hardware on the processor in response to executing the programmed code.

11. The method of claim 10, wherein controlling one or more functions of the processor in response to executing the programmed code further includes:
controlling a non-performance critical function.

12. The method of claim 11, wherein the non-performance critical function is selected from the group consisting of:
cache flushing, cache invalidation, setting processor features, reading processor features, machine check handling, floating point calculations, processor diagnosis, architecture handling for backward compatibility, authentication, platform management interrupt, diagnostic functions and debug functions.

13. A system, comprising:
a bus;
a processor including a plurality of machine specific registers, wherein each one of the plurality of machine specific registers is associated with one or more functional units of the processor; and
a computer readable medium external to the processor and coupled to the processor by the bus, the computer readable medium to store instructions to implement microcode functions which result in changing a value of at least one bit in at least one of the plurality of machine specific registers.

14. The system of claim 13, wherein the computer readable medium is firmware.

15. The system of claim 13, wherein the plurality of machine specific registers includes a bank of registers associated with one of the one or more functional units.

16. The system of claim 13, wherein one of the one or more functional units is an internal bus controller.

17. The system of claim 13, wherein one of the one or more functional units is an internal data cache of the processor.

18. The system of claim 17, wherein the instructions implement microcode functions by updating the at least one of the plurality of machine specific registers associated with the internal data cache of the processor.

19. The system of claim 18, wherein the instructions implement microcode functions by setting at least one bit to invalidate a line of the internal data cache of the processor.

20. The system of claim 13, wherein the instructions implement microcode functions by triggering processor hardware logic and by manipulating the plurality of machine specific registers.

21. A method, comprising:
storing microcode on a computer readable medium external to a processor;
executing the microcode using the processor, wherein the processor includes a plurality of machine specific registers associated with at least two functional units of the processor; and
controlling one of the at least two functional units of the processor in response to executing the microcode by modifying a value of at least one bit included in one of the plurality of machine specific registers.

22. The method of claim 21, wherein modifying a value of at least one bit included in one of the plurality of machine specific registers associated with one of the at least two functional units of the processor operates to affect the behavior of an other one of the at least two functional units of the processor.

23. The method of claim 21, wherein a logical source register and a logical destination register for executing an instruction of the microcode are selected from the plurality of machine specific registers.

24. The method of claim 21, wherein the at least two functional units are linked by a communication bus to a data control unit to fetch an instruction of the microcode from the computer readable medium external to a processor.

25. The method of claim 21, wherein controlling one of the at least two functional units of the processor in response to executing the microcode further includes:
controlling a non-performance critical function.

26. The method of claim 25, wherein the non-performance critical function is selected from the group consisting of:
cache flushing, cache invalidation, setting processor features, reading processor features, machine check handling, floating point calculations, processor diagnosis, architecture handling for backward compatibility, authentication, platform management interrupt, diagnostic functions and debug functions.

27. An article comprising a machine-accessible medium having associated data, wherein the data, when accessed, results in a machine performing:
storing microcode in firmware external to a processor;
executing the microcode by the processor;
updating one or more machine specific registers associated with a logic unit on the processor in response to the executing of the programmed code; and
controlling one or more functions of the logic unit on the processor based on a value stored in the one or more machine specific registers.

28. The article of claim 27, wherein the machine-accessible medium further includes data, which when accessed by the machine, results in the machine performing:
moving a value from a general purpose register of the processor to the one or more machine specific registers.

29. The article of claim 27, wherein the machine-accessible medium further includes data, which when accessed by the machine, results in the machine performing:
reprogramming the microcode in the firmware.

30. An apparatus, comprising:
a first logic unit included in a processor; and
at least two machine specific registers associated with the logic unit, the at least two machine specific registers to trigger hardware logic functions associated with the processor when a selected one of the at least two machine specific registers is updated in response to executing a microcode instruction fetched from a memory external to the processor.

31. The apparatus of claim 30, further comprising:
a second logic unit associated with a selected one of the at least two machine specific registers.

32. The apparatus of claim 31, wherein changing a value of at least one bit in a selected other one of the at least two machine specific registers affects the behavior of the second logic unit.
